(19) United States
(12) Patent Application Publication
(10) Pub. No.: US 2011/0201124 A1
(43) Pub. Date: Aug. 18, 2011

(54) OZONE REDUCING Y-PIPE FOR LOW COST OZONE SENSOR

(75) Inventors: Brian Michael Schork, Louisville (KY); John Besore, Prospect (KY); Yogesh Kumar Allimalli, Andhra Pradesh (IN); Larry Miller, Louisville (KY)

(73) Assignee: General Electric Company

(21) Appl. No.: 12/707,779

(22) Filed: Feb. 18, 2010

(51) Int. Cl. G01N 31/10

(52) U.S. Cl. 436/135; 422/129

(57) ABSTRACT

An ozone detection system includes a source of sample gas containing a concentration of ozone. The system further includes a first airflow passageway for receiving a first sample of gas from the source. The first airflow passageway includes a catalytic scrubber to reduce ozone content in the sample gas and a second airflow passageway receives a second sample of gas from the source. A third airflow passageway results from the convergence of the first and second airflow passageways wherein the reduced sample gas and the unaltered sample gas are combined to form a diluted sample gas. A sensor is provided for sensing the ozone concentration in the diluted sample gas received from the third airflow passageway. A processor is provided operative to calculate the actual concentration of ozone in the sample gas as a function of the sensed concentration of the diluted sample.

### BACKGROUND OF THE DISCLOSURE

The present disclosure relates to gas detection, more specifically to an ozone detection system and method. The ozone detection system finds particular application in consumer grade appliances, although it will be appreciated that selected aspects may find use in related applications encountering the same issues of a cost effective ozone sensor with good resolution at high ozone concentrations in order to regulate proper ozone levels.

Ozone (O₃) is a colorless gas which has both beneficial and detrimental effects on health and the environment. Ozone is a naturally occurring component resulting from a lighting storm giving that fresh air smell. It can be produced by the ultraviolet rays of the sun reacting with the Earth's upper atmosphere, which creates a protective ozone layer, or it can be created artificially with an ozone generator. However, ozone resulting from human activity at or close to the ground is a main component of smog, which adversely affects respiratory health, agricultural crops, and forests. While the ozone alone is not detrimental at ground level, it mixes with other more dangerous compounds. These other components of smog include nitrogen oxides (NOₓ), volatile organic compounds (VOC's), sulfur dioxide, acidic aerosols and gases, and particulate matter.

The ozone molecule contains three oxygen atoms whereas the oxygen molecule contains only two. Ozone is a very reactive and unstable gas with a short half-life before it reverts back to oxygen. Ozone is one of the most powerful and rapid acting oxidizers man can produce, and will oxidize most bacteria, mold and yeast spores, organic material and viruses.

Ozone is not only a very powerful oxidizing agent but also a very powerful non-chemical disinfectant. It has the unique feature of decomposing to a harmless nontoxic environmentally safe material, namely oxygen. In Europe, ozone is used for many purposes: color removal, taste and odor removal, turbidity reduction, organics removal, micro flocculation, iron and manganese oxidation, and most commonly, bacterial disinfection and viral inactivation. Most of these applications are based on ozone's high oxidizing power. When used in water treatment, ozone can be introduced at different points in the process, depending on its intended application. For iron and manganese oxidation or to induce flocculation, it is usually introduced early, and when used for taste and odor removal it is introduced at an intermediate point. In European water treatment practices, ozonation is recognized as a preferred method of virus inactivation rather than just an alternative to the use of chlorine for disinfection.

Nine out of ten diseases, including the common cold and the flu, are caused by water or airborne bacteria and viruses. Like chlorine, ozone kills microorganisms. The sterilization action of ozone is by “direct kill attack” and oxidation of the biological material. The rate of bacteria killed by ozone is 3500 times faster than with chlorine. Virus destruction with ozone is instantaneous, safe and foolproof, as ozone is nature's own purifier. Chlorine's reactive oxidant is hypochloric acid which is formed when chlorine is dissolved in water. This powerful oxidant will have significant long term negative effects on our water sources. Ozone, on the other hand, has no side effects as far as the treatment of water is concerned. It has properly been described as the “add-nothing” sterilant.

Current ozone sensing technologies are not easily adapted to work in consumer grade appliances. Some technologies are cross-sensitive between ozone, humidity and temperature. While others such as electrochemical type sensors are very expensive and last only approximately two years. Furthermore, current lower cost ozone sensors do not have adequate resolution at higher concentrations of ozone such as around 20 parts per million or higher. Thus, there exists a need to overcome these problems in order to provide for a cost-effective ozone detecting system operating with higher ozone concentrations.

Even in light of recent advances, the industry continues to lack a cost effective ozone detection system, useful in consumer grade appliances, with the ability to detect high ozone concentration levels by reducing total ozone content and then calculating an undiluted sample gas concentration using conventional ozone type sensors.

### SUMMARY OF THE DISCLOSURE

In one aspect, the present disclosure relates to an ozone detection system for detecting the ozone concentration in a sample gas, e.g., ozone laden air, which includes a source of sample gas containing a concentration of ozone. The system further includes a first airflow passageway for receiving a first sample of gas from the source. The first airflow passageway includes a catalytic scrubber to reduce ozone content in the sample gas. A second airflow passageway receives a second sample of gas from the source. A third airflow passageway results from the convergence of the first and second airflow passageways wherein the reduced sample gas and the unaltered sample gas are combined to form a diluted sample gas. A sensor is provided for sensing the ozone concentration in the diluted sample gas received from the third airflow passageway. A processor operative to calculate the actual concentration of ozone in the sample gas as a function of the sensed concentration of the diluted sample is further provided.

In another aspect, the present disclosure relates to a method to detect ozone concentration in use of a consumer grade appliance that includes providing a source of sample containing a concentration of ozone. The method further includes providing a first airflow passageway for receiving a first sample gas from the source. The first airflow passageway includes a catalytic scrubber to reduce ozone content in the sample gas. A second airflow passageway is provided for receiving a second sample of gas from the source. The first airflow passageway and the second airflow passageway converge into a third airflow passageway in which the gases from the first and second airflow passageways are combined to form a diluted sample gas. A sensor is provided for sensing the ozone concentration in the diluted sample in the third airflow passageway. A processor is further provided operative to calculate the actual concentration of ozone in the sample gas using the date from the sensor.

In one aspect, the present disclosure relates to an ozone detection system for detecting the ozone concentration in a sample gas, e.g., ozone laden air, which includes a source of sample gas containing a concentration of ozone. The system further includes a first airflow passageway having a diameter D₁ which includes a catalytic scrubber to reduce ozone content in the first sample of gas. The catalytic scrubber includes a metal oxide catalyst. A second airflow passageway has a diameter D₂ for receiving a second sample of gas from the source wherein D₂ is less than D₁. A third airflow passageway results from the convergence of the first and second airflow passageways wherein the reduced sample gas and the unaltered sample gas are combined to form a diluted sample gas. A sensor is provided for sensing the ozone concentration in the diluted sample gas received from the third airflow passageway wherein the sensor is a heated metal oxide semiconductor. A processor is further provided operative to calculate the actual concentration of ozone in the sample gas as a function of the data from the sensor and the first and second diameters.

In another aspect, the disclosure relates to an ozone detection system for detecting the ozone concentration in a sample gas, e.g., ozone laden air, which includes a source of sample gas containing a concentration of ozone. The system further includes a first airflow passageway having a diameter D₁ which includes a catalytic scrubber to reduce ozone content in the first sample of gas. The catalytic scrubber includes a metal oxide catalyst. A second airflow passageway has a diameter D₂ for receiving a second sample of gas from the source wherein D₂ is less than D₁. A third airflow passageway results from the convergence of the first and second airflow passageways wherein the reduced sample gas and the unaltered sample gas are combined to form a diluted sample gas. A sensor is provided for sensing the ozone concentration in the diluted sample gas received from the third airflow passageway wherein the sensor is a heated metal oxide semiconductor. A processor is further provided operative to calculate the actual concentration of ozone in the sample gas as a function of the data from the sensor and the first and second diameters.

A primary benefit realized by the ozone detection system is the ability to generate data from a reduced ozone gas sample that is then used to calculate actual ozone levels above those that can be accurately detected by lower cost sensors, so that the appliance can operate to eliminate ozone from ozone-rich samples.

Still other features and benefits of the ozone detection system according to the invention will become more apparent from reading and understanding the following detailed description.

### BRIEF DESCRIPTION OF THE DRAWINGS

FIG. 1 is a cross-sectional view of an ozone detection system according to an exemplary embodiment; and

FIG. 2 is a cross-sectional view of an ozone detection system according to an exemplary embodiment.

### DETAILED DESCRIPTION OF THE PREFERRED EMBODIMENTS

The current inventive ozone detection system has the ability to measure ozone in small and large concentrations using a relatively low cost ozone sensor that generally is capable of ozone detection only at much lower levels. This is achieved in the inventive system, by diluting the original sample, calculating the ozone level in the diluted sample, and using this data to calculate actual ozone levels in the original sample gas. This eliminates the need to use more sensitive, costly sensors and yet still allows the appliance to be suitable for use in higher ozone environments. For example, the current ozone sensing system may be incorporated into a deodorizing- or sanitizing-type consumer product such as those products set forth in U.S. Ser. No. 12/621,947 to our common assignee, among others. In accordance with one embodiment of the present disclosure, a sensor operative to detect ozone concentrations in the range of 0.5-10 ppm is used to sense the ozone concentration of gases having concentration in the 15-30 ppm range by using the sensor.

The present disclosure provides a system for use in consumer grade appliances that has the ability to measure ozone in small and large concentration. With the invention comes the ability to regulate ozone and detect minimum threshold values for regulatory and governing body agencies.

The ozone detection system of the present disclosure resolves the issue of poor resolution when sensing or measuring a sample having a high ozone concentration by diluting the ozone concentration of the gaseous air by a fixed percentage. A processor calculates the actual ozone concentration based on the diluted reading. In one embodiment, the system contains a catalytic scrubber positioned within a first airflow passageway. The catalytic scrubber contains a catalyst to reduce the ozone level percent to one accurately detectable by the lower cost sensor. The reduced sample gas is mixed with unaltered sample gas passing through a second airflow passageway. The first and second airflow passageways have diameters sized to produce airflow rates having a known ratio to each other. Based upon the relative airflow rates, the sensed concentration of the diluted sample air passing across the low cost sensor, a computer software program calculates the actual ozone concentration. This information is then used in a computer software program to convert the diluted reading back to the actual ozone concentration.

In another embodiment, the unaltered sample gas from the second airflow passageway is diluted with a flow of ambient air that is substantially ozone-free. In this embodiment, no scrubber is necessary. Based upon the relative airflow rates, the sensed concentration of the diluted sample air passing across the low cost sensor, a computer software program calculates the actual ozone concentration. This information is then used in a computer software program to convert the diluted reading back to the actual ozone concentration.

In yet another embodiment, a valve is positioned within the first airflow passageway to allow for closing off the reduced sample gas in order to read the actual undiluted ozone level during low concentration levels. Based on the sensed concentration of the undiluted sample air passing across the low cost sensor, a computer software program calculates the actual ozone concentration. This information is then used in a computer software program to convert the undiluted reading back to the actual ozone concentration.

Once determined, the actual ozone level data can be used to regulate the level of reduction or removal that must be performed by the appliance in order to meet government or other regulatory standards of operation for the appliance in question.

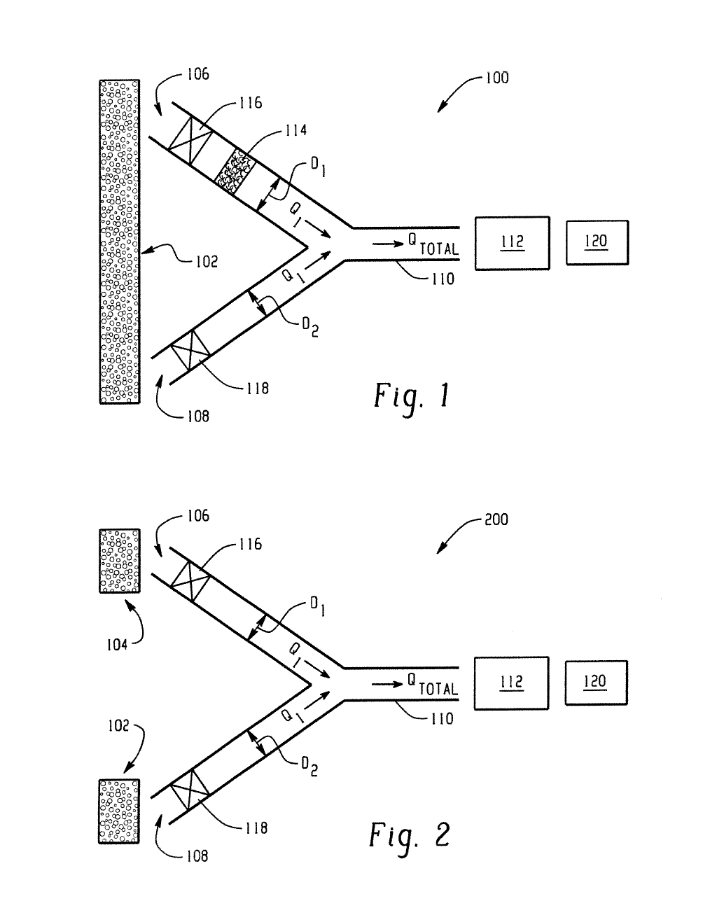

FIGS. 1 and 2 are flow diagrams of exemplary ozone detection systems 100 and 200 in accord with the present disclosure. With respect to FIGS. 1 and 2, the ozone detection systems 100 and 200 include a source 102 of sample gas containing a concentration of ozone. The gaseous ozone from the source 102, for example, can be at least about 15 parts per million (ppm), and generally less than about 30 ppm, e.g., about 20 ppm. With respect to FIG. 2, the ozone detection system 200 may further include a source 104 of sample ambient air. The ozone detection systems 100, 200 include a first airflow passageway 106, a second airflow passageway 108, a third airflow passageway 110 and a sensor 112.

In the embodiment of FIG. 1, the first airflow passageway 106 receives a first sample of gas from the source 102. The first airflow passageway 106 includes a catalytic scrubber 114 to reduce ozone content in the sample gas containing a concentration of ozone. The second airflow passageway 108 receives a second sample of gas from the source 102. Valve 116 is operative to admit the sample gas into the first airflow passageway 106 while valve 118 is operative to admit the second sample gas into the second airflow passageway 108. For purposes of this application the word valve refers to any type of device known to shut off, release, dose, distribute or mix fluids or gases. Gas from the first airflow passageway 106 and the second airflow passageway 108 are then mixed to form a diluted sample gas when these passageways converge into the third airflow passageway 110. In the embodiment of FIG. 1, the first airflow passageway and the second airflow passageway 106, 108 converge into the third airflow passageway 110 to form a y-shaped pipe. Although, it can be appreciated the passageways may form other shapes that can be configured to a particular grade appliance.

The first airflow passageway 106 which includes the catalytic scrubber 114 has a diameter D₁. The second airflow passageway 108 has a diameter D₂. The flow rates in the first and second passageways are adjusted to the desired relative relationship by selection of the diameters D₁ and D₂. The flow rates in the first and second passageways are adjusted to the desired relative relationship by selection of the diameters D₁ and D₂. In the illustrative embodiment, D₁ and D₂ are selected to provide for equal flow rates in each of these passageways. Consequently, the second airflow passageway 108, which passes only an unaltered sample gas, has a diameter that is sufficiently less than that of the first airflow passageway 106 to compensate for the presence of the catalytic scrubber 114 in passageway 106 which impedes the flow through passageway 106. It is to be appreciated that other flow rate ratios could be employed provided only that the ratio be known. Increasing the ratio of D₁ to D₂ increases the operating range for the given sensor.

The catalytic scrubber 114 contains a catalytic material which is used to reduce the ozone level in the original sample gas in order to form a diluted gaseous sample. The catalytic material may be a metal oxide catalyst selected from the group of manganese oxide, cobalt oxide, copper oxide, nickel oxide, and combinations thereof. In an exemplary embodiment, the catalytic material is the metal oxide catalyst manganese oxide. The metal oxide catalyst is used to reduce the ozone level by at least about 50 percent, and generally less than about 95 percent, e.g. about 65 percent. The efficiency of the metal oxide catalyst is based upon the geometry of the catalyst provided by the supplier. However, it can be appreciated the efficiency can be tested and verified through methods known in the art.

As above described, the diameters D1 and D2 of the passageways 106 and 108 respectively, are chosen to provide a known predetermined ratio of the flow rate of the reduced ozone air from the first airflow passageway 106, Q1 to the flow rate of the unaltered ozone air from the second airflow passageway 108. In the embodiment of FIG. 1 the diameters are chosen to provide a ration of approximately 1, that is, flowrates Q₁ and Q₂, are approximately equal. Because of the presence of the catalyst, in passabway 108, D1 is greater than D2. The flow rate Q_{Total} of the diluted gas in the third airflow passageway is satisfied by the equation:

Q_{Total}=Q₁+Q₂;
where Q_{Total}=airflow rate for diluted sample gas airflow rate in the third airflow passageway
Q₁=airflow rate for the reduced sample gas in the first airflow passageway; and
Q₂=airflow rate for unaltered sample gas in the second airflow passageway

The diameters of the first and second airflow passageways 106, 108 are approximately determined by obtaining the pressure drop of the supplied catalyst based on expected flow rates. The—Bernoulli equation is used assuming average density and velocity in the airflow passageways. The equation is as follows and would be used for each airflow passageway individually.

P₁/density+V₁²+Z₁=P₂/density+V₁²+Z₂+“Head Loss” in the airflow passageway
wherein:
   V=velocity in the airflow passageway
   P₁=inlet pressure of the airflow passageway
   P₂=outlet pressure of the airflow passageway
   Z=elevation
      The first and second airflow passageways 106, 108 are at the same elevation so the Z term disappears. The new equation is:

P₁/density+V₁²=P₂/density+V₁²+“Head Loss” in airflow passageway

The head loss in the airflow passageway is derived from the equation:

Head loss=f*L*V²/2*G*D
wherein:
   G=a constant
   L=length of airflow passageway
   f=friction factor related to the roughness of the airflow passageway
   V=velocity in the airflow passageway
   D=inside diameter of the airflow passageway
      This is an iterative solution assuming a velocity in order to arrive at the “Head Loss” term. The first equation is solved to arrive at the velocity and then iterates until the two velocities are equal. Finally, knowing the velocity, the flow rate Q is calculated from the equation:

Q=V*A
wherein:
   Q=flowrate
   V=velocity
   A=cross sectional area of the pipe
      Therefore, the flow rates of the first and second airflow passageways 104, 106 are balanced by adjusting the diameters in the equations while including the pressure drop across the catalyst in the first airflow passageway 104.

It should be appreciated to one skilled in the art would know that the ratio of Q₁ to Q₂ and the efficiency of the scrubber relates to the dilution of the sample gas being tested which in turn relates to the range of concentrations which the system can detect. For example, it may be assumed the scrubbed or ambient gas has a zero concentration of ozone. Based on this assumption, if the ratio of Q₁ to Q₂ equals 1 the concentration of the diluted gas is presumably one-half the concentration of the actual test gas. The illustrative embodiment is described as using a sensor with an operating range of 0.5-10 ppm. If the sample gas is diluted by half, the operating range for the system would be 1-20 ppm. For the system to be effective in the upper end of the 15-30 ppm range, the ratio of Q₁ to Q₂ would be closer to 2 resulting in an effective operating range of 1.5-30 ppm. However, in an actual illustrative embodiment, the scrubber has an efficiency of approximately 65%. If the ratio of Q₁ to Q₂ equals 1, the concentration of the diluted gas is approximately two-thirds of the concentration of the test gas. This would result in an operating range for the system of 0.75-15. So, for such a scrubber and sensor, the ratio of Q₁ to Q₂ would need to be changed to enable the system to operate in the 15-30 ppm range. Since the relative sizing of the passageways depends on the desired ratio of Q₁ to Q₂ which in turn depends on the intended operating range for the system and the operating range of the sensor, a more complete explanation of these relationships enables adapting the system to other operating ranges using other sensors; not to mention making sure the parameters described for the illustrative embodiments are operative in the ranges attributed to them.

It can be appreciated as an alternative and more accurate approximation, the system may be modeled using standard computational flow dynamics (CFD) software such as, AFT Arrow, AFT Fathom, Fluent, or CFX, and combinations thereof or other such standards. Furthermore, after sizing the passageways for a desired ratio of Q₁ to Q₂ using theoretical principals, further adjustments are made using experimental methods to fine tune the ratio of Q₁ to Q₂.

In the embodiment of FIG. 2, the first airflow passageway 106 receives a first sample of ambient air from the source 104 whereby the ambient air is substantially ozone free. It can be appreciated in this embodiment the first airflow passageway 106 does not include a catalytic scrubber. Thus the determination of the appropriate diameters D1 and D2 is greatly simplified as there is no need to accommodate the head loss created by the presence of a scrubber in passageway 106. Other than the resulting difference in diameters and the admission of ambient air into passageway 106 via valve 116, the system operates in the manner described above with reference to the embodiment of FIG. 1.

The ozone content of the actual consumer grade appliance air can be calculated based on the air flow rates and efficiency of the metal oxide catalyst. A processor 120 uses the dilution ratio to calculate the concentration of the ozone in the test gas as a function of the diluted sample gas reading taken by the sensor 112 and the dilution ratio to arrive at the actual ozone concentration. The ozone sensor may be any sensor capable of assessing ozone concentration at parts per million (ppm) or parts per billion (ppb) levels and then transmitting this level data to the processor. In the embodiments of FIGS. 1 and 2, the sensor is a conventional heated metal oxide semiconductor (HMOS) type sensor 200 of the type commercially available from e2V, Incorporated, with model or part number MiCs-oz-47 Ozone Sensing Head with Smart Transmitter PCB. Although, it may be appreciated other similar type of sensors may be suitable. A heated metal oxide semiconductor sensor works by heating a platinum substrate to a temperature of about 300 degrees Fahrenheit. The platinum substrate at this temperature is sensitive to ozone. As the sensor detects ozone a proportional signal is sent to the electronics in the sensor. The range for this sensor is about 0.5 to about 10.0 ppm of ozone.

The invention has been described with reference to the preferred embodiments. Obviously, modifications and alterations will occur to others upon reading and understanding the preceding detailed description. It is intended that the invention be construed as including all such modifications and alterations.

Having thus described the invention, it is now claimed:

1. An ozone detection system comprising:
a source of sample gas containing a concentration of ozone;
a first airflow passageway for receiving a first sample of gas from the source, the first airflow passageway comprising a catalytic scrubber to reduce ozone content in the sample gas;
a second airflow passageway for receiving a second sample of gas from the source;
a third airflow passageway that results from the convergence of the first and second airflow passageways wherein the reduced sample gas and the unaltered sample gas are combined to form a diluted sample gas;
a sensor for sensing the ozone concentration in the diluted sample gas received from the third airflow passageway; and
a processor operative to calculate the actual concentration of ozone in the sample gas as a function of the sensed concentration of the diluted sample.

2. The system of claim 1, wherein the first airflow passageway and the second airflow passageway converge into the third airflow passageway to form a y-shaped pipe.

3. The system of claim 1, wherein the first airflow passageway has a diameter D₁ and the second airflow passageway has a diameter D₂.

4. The system of claim 3, wherein D₁>D₂.

5. The system of claim 1, wherein the sensor is a heated metal oxide semiconductor sensor.

6. The system of claim 1, wherein the catalytic scrubber comprises a metal oxide catalyst to reduce the gaseous ozone.

7. The system of claim 6, wherein the metal oxide catalyst is selected from the group consisting of manganese oxide, cobalt oxide, copper oxide, nickel oxide, and combinations thereof.

8. The system of claim 6, wherein the metal oxide catalyst is manganese oxide.

9. A method to detect ozone concentration in use of a consumer grade appliance comprising:
providing a source of sample gas containing a concentration of ozone;
providing a first airflow passageway for receiving a first sample gas from the source, the first airflow passageway comprising a catalytic scrubber to reduce ozone content in the sample gas;
providing a second airflow passageway for receiving a second sample of gas from the source;
converging the first airflow passageway and the second airflow passageway into a third airflow passageway in which the gases from the first and second airflow passageways are combined to form a diluted sample gas;
providing a sensor for sensing the ozone concentration in the diluted sample in the third airflow passageway, and
providing a processor operative to calculate the actual concentration of ozone in the sample gas using the data from the sensor.

10. The method of claim 9, further providing converging the first airflow passageway and the second airflow passageway into the third airflow passageway to form a y-shaped pipe.

11. The method of claim 9, further providing the first airflow passageway to have diameter D₁ and the second airflow passageway to have a diameter D₂.

12. The method of claim 11, further providing D₁>D₂.

13. The method of claim 9, further providing the sensor to be a heated metal oxide semiconductor sensor.

14. The method of claim 9, further providing the catalytic scrubber comprising a metal oxide catalyst.

15. The method of claim 14, further providing selecting the metal oxide catalyst from the group consisting of manganese oxide, cobalt oxide, copper oxide, nickel oxide, and combinations thereof.

16. The method of claim 14, further providing the metal oxide catalyst to be manganese oxide.

17. An ozone detection system comprising:
a source of sample gas containing a concentration of ozone;
a first airflow passageway for receiving a first sample of gas from the source, the first airflow passageway having a diameter D₁ comprising a catalytic scrubber to reduce ozone content in the first sample of gas, the catalytic scrubber comprising a metal oxide catalyst;
a second airflow passageway having a diameter D₂ for receiving a second sample of gas from the source, wherein D₂ is less than D₁;
a third airflow passageway that results from the convergence of the first and second airflow passageways wherein the reduced sample gas and the unaltered sample gas are combined to form a diluted sample gas;
a sensor for sensing the ozone concentration in the diluted sample gas received from the third airflow passageway, wherein the sensor is a heated metal oxide semiconductor; and
a processor operative to calculate the actual concentration of ozone in the sample gas as a function of the data from the sensor and the first and second diameters.

18. The system of claim 17, wherein a valve is positioned within the first airflow passageway to allow for closing off the reduced sample gas in order to read the actual undiluted ozone level during low concentration times.

19. An ozone detection system for determining the ozone concentration of a sample of gas comprising:
a source of sample gas containing a concentration of ozone;
a source of sample ambient air;
a first airflow passageway for receiving the sample of ambient air from the source;
a second airflow passageway for receiving the sample of ozone containing gas;
a third airflow passageway that results from the convergence of the first and second airflow passageways wherein the sample ambient air and the ozone containing sample gas are combined to form a diluted sample gas;
a sensor for sensing the ozone concentration in the diluted sample gas received from the third airflow passageway, wherein the sensor is a heated metal oxide semiconductor; and
a processor operative to calculate the actual ozone concentration of ozone in the sample gas using the data from the sensor.

20. The system of claim 19, wherein the first airflow passageway and the second airflow passageway converge into the third airflow passageway to form a y-shaped pipe.
